(19) United States
(12) Patent Application Publication
(10) Pub. No.: US 2017/0351104 A1
(43) Pub. Date: Dec. 7, 2017

(54) APPARATUS AND METHOD FOR OPTICAL IMAGING

(71) Applicant: BAE SYSTEMS plc, London (GB)

(72) Inventors: JAMES DUNCAN REVELL, Bristol South Gloucestershire (GB); MARK ROBERT GOODALL, Bristol South Gloucestershire (GB); GARY MARTIN CROSS, Bristol South Gloucestershire (GB)

(73) Assignee: BAE SYSTEMS plc, London (GB)

(21) Appl. No.: 15/534,690

(22) PCT Filed: Feb. 4, 2015
(86) PCT No.: PCT/GB2015/050294

§ 371 Date: Jun. 9, 2017

(30) Foreign Application Priority Data
Dec. 9, 2014 (GB) 1421858.0

(51) Int. Cl. G02B 27/10; H04N 5/225; G02B 27/12; H04N 7/18; H04N 5/232

(52) U.S. Cl. CPC G02B 27/1066; H04N 7/183; H04N 5/23232; G02B 27/126; H04N 5/2254; H04N 5/23212

(57) ABSTRACT

Optical apparatus for use with an image capture device having an optical input and an image sensor (22) defining a principal optical axis therebetween, the apparatus being configured to provide, via said input, a plurality of substantially parallel, spaced-apart optical beams to said image sensor (22), and comprising:
a first optical unit (26) comprising a plurality of optical elements (10, 12, 14, 16, 18, 20), at least a first one of said optical elements being a first refractive element (12, 14, 18, 20) for refracting an optical beam incident thereon through substantially 90°; and
a plurality of focusing lenses (lens0, lens1, lens2, lens3, lens4, lens5), each focusing lens being associated with a respective optical element and being configured to direct a respective incident optical beam thereon;
wherein the focusing lens associated with said refractive element is arranged and configured to direct an incident optical beam thereon at substantially 90° to said principal optical axis, and the refractive element is arranged and configured such that, in use, the resultant refracted optical beam is substantially parallel to said principal optical axis as it reaches said image sensor (24).

This invention relates generally to an apparatus and method for optical imaging and, more particularly to an optical lens, and method of optical imaging, for enabling a plurality of fields of view in respect of an area of interest to be captured simultaneously.

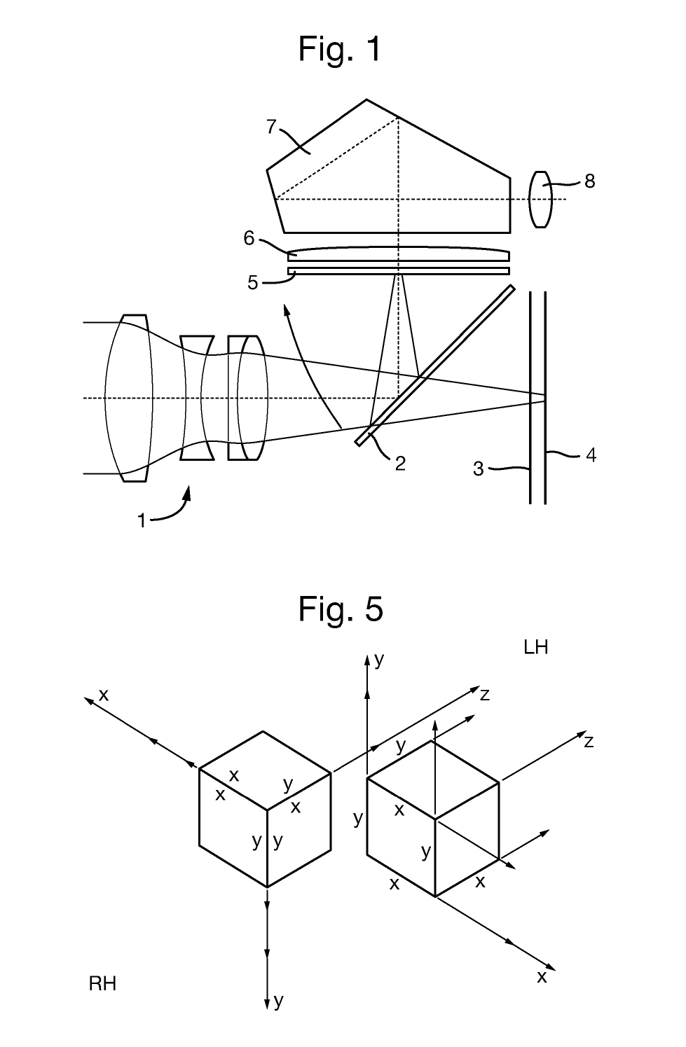

A typical image capture device, such as a digital SLR (single lens reflex) camera, is illustrated schematically in FIG. 1 of the drawings, and comprises a single lens or lens assembly 1 mounted in-line with a focal plane shutter 3 and an image sensor 4. In addition, a reflex mirror 2 is provided which selectively directs the light from the lens 1, through an optical arrangement (focusing screen 5, condenser lens 6 and pentaprism/pentamirror 7) to a viewfinder 8. In this configuration, light travels through the lens 1, then to the mirror 2 that alternates to send the image to either the viewfinder 8 or the image sensor 4, as required. Digital SLR cameras typically use interchangeable lenses with a lens mount, and such lens mounts are increasingly commonly of a universal type, such as the conventional C or CS mount.

Of course, other digital cameras of various configurations exist, but they all share the characteristic whereby a single lens (or lens assembly) is mounted in-line (relative to the principal axis of its field of view) with the image sensor, such that a single field of view, characterised by that principal axis, can be captured using a single camera.

There are many applications in which it is required to capture images from several fields of view in respect of the same area of interest, from different respective aspects, simultaneously. For example, CCTV systems, used to monitor a specified area of interest, which capture respective individual image sets from each of the fields of view (defined by the respective principal axis of the lens/image sensor assembly), and data representative of the captured sets of images is transmitted in the form of individual respective feeds to one or more display monitors and/or data storage devices.

In applications of this type, and others, cost and available space are defining (and limiting) factors in the overall configuration of the system: i.e. the number of cameras that can be used and the locations and orientations at which they can be mounted, and there is invariably a trade-off, as a result, between the required coverage of the area of interest and the number of cameras that can be physically deployed within the space available.

This becomes an even greater issue in, for example, optical systems that use egomotion for determining and monitoring position and/or orientation of a moving platform. Egomotion is defined as the 3D motion of a camera within an environment. The goal of estimating the egomotion of a camera is to determine the 3D motion of that camera using a sequence of images taken by the camera. The process of estimating a camera's motion within an environment involves the use of visual odometry techniques on a sequence of images captured by the moving camera. This may be done by feature detection to construct an optical flow from two image frames in a sequence, but other methods of extracting egomotion information from images exist.

The task of visual odometry is, therefore, to estimate motion of a camera and, by association, the platform to which it is attached, using a sequence of camera images.

A single view from a monocular camera, without additional constraints can only recover scale and not depth, also referred to as range or distance, prohibiting a 6DOF pose being estimated. However, it has been shown that it is possible to estimate a 6DOF pose using stereo cameras or multiple cameras with overlapping views.

Nistér, et al, “Visual Odometry”, IEEE Computer Society Conference on Computer Vision and Pattern Recognition, volume 1, pages 652-659, 2004 proposes a technique which uses a calibrated stereo camera system with overlapping fields of view for visual navigation. The proposed algorithm employs a stereo camera system to recover 3D world points up to an unknown Euclidean transformation. In Frahm et al, “Pose Estimation for Multi-Camera Systems”, DAGM, 2004, a 6DOF estimation technique using a multi-camera system is introduced, which assumes overlapping camera views to obtain the depth of the camera motion.

However, there are some disadvantages to using stereo or multiple overlapping camera views for calculating depth. Importantly, the estimated depth accuracy is dependent on very precise intrinsic and extrinsic camera calibration. The use of stereo cameras also reduces the useable field of view, because only features that lie in the intersection of the field of view of two or more cameras can be used.

For a single monocular camera, it is not possible to recover depth in the optical axis for arbitrary camera motion when using monocular imaging without using some additional information such as distance and attitude of the camera from the ground plane. On the other hand, the provision of several monocular cameras, each providing a different field of view, can be an issue in some applications where size, weight and power (SWaP) are significant limiting factors.

Aspects of the present invention are intended to address at least some of these issues and, in accordance with one aspect of the present invention, there is provided optical apparatus for use with an image capture device having an optical input and an image sensor defining a principal optical axis therebetween, the apparatus being configured to provide, via said input, a plurality of substantially parallel, spaced-apart optical beams to said image sensor, and comprising:
a first optical unit comprising a plurality of optical elements, at least a first one of said optical elements being a first refractive element for refracting an optical beam incident thereon through substantially 90°; and
a plurality of focusing lenses, each focusing lens being associated with a respective optical element and being configured to direct a respective incident optical beam thereon;

wherein the focusing lens associated with said refractive element is arranged and configured to direct an incident optical beam thereon at substantially 90° to said principal optical axis, and the refractive element is arranged and configured such that, in use, the resultant refracted optical beam is substantially parallel to said principal optical axis as it reaches said image sensor.

The first optical unit may, in accordance with one exemplary embodiment, comprise two optical elements: a first optical element comprising said refractive element, and a second optical element configured to allow an optical beam incident thereon to propagate substantially straight through, wherein the focusing lens associated therewith is arranged and configured to direct an incident optical beam thereon substantially parallel to said principal optical axis, said first and second optical elements being relatively positioned within said optical unit such that the respective optical beams output therefrom are spaced-apart and substantially parallel.

In another exemplary embodiment, the first optical unit may comprise a third optical element being a second refractive element for refracting an optical beam incident thereon through substantially 90°, wherein the focusing lens associated with said second refractive element is arranged and configured to direct an incident optical beam thereon at substantially 90° to said principal optical axis and substantially 90° to the incident optical beam directed onto said first refractive element, and the second refractive element is arranged and configured such that, in use, the resultant refracted optical beam is substantially parallel to said principal optical axis as it reaches said image sensor.

The optical elements may be housed in or on a single mount configured to be held within a lens mount of an image capture device. Thus, the resultant apparatus can be retro-fitted to an existing digital SLR camera via, for example its standard C/Cs mounting function.

The incident optical beams may be directed to the three respective optical elements define three orthogonal axes of a left- or right-handed coordinate system.

Iris adjustment is provided in at least some conventional digital SLR cameras, which enables control of the aperture to allow different amounts of light through the imaging system. In one exemplary embodiment of the present invention, iris adjustment means may be provided in respect of each of the optical elements.

In another exemplary embodiment of the invention, the apparatus may comprise a second optical unit comprising three further optical elements: a fourth optical element for propagating an optical beam incident thereon substantially straight through, and two refractive elements, each for refracting an optical beam incident thereon through substantially 90°, and the apparatus comprises three further focusing lenses, each associated with a respective one of said three further optical elements, wherein a first of said focusing lenses is arranged and configured to direct an incident optical beam on said fourth optical element substantially parallel to said principal optical axis, and each of the other two of said focusing lenses are arranged and configured to direct an incident optical beam on a respective one of said refractive elements at substantially 90° to said principal optical axis and at substantially 90° to each other, such that the optical beams output from said second optical unit are spaced apart and substantially parallel to said principal optical axis and each other.

The first optical unit may comprise a first set of three optical elements for receiving incident optical beams in respect of three orthogonal axes of a left-handed coordinate system and outputting three parallel, spaced-apart optical beams representative thereof, and said second optical unit comprises a second set of three optical elements for receiving incident optical beams in respect of three orthogonal axes of a right-handed coordinate system and outputting three parallel, spaced-apart optical beams representative thereof. This has the additional advantage of increasing the aspect ratio of the imaging system field of view, i.e. it enables a consistently good coverage of the intended field of view, even in the event of an obstruction within one of the axes.

The first and second optical units may be mounted or otherwise connected together to form an array of optical elements.

The apparatus may further comprise a control function for enabling a user to select, as an output from said optical unit, said optical beams representative of said left-handed coordinate system, said optical beams representative of said right-handed coordinate system, or the optical beams representative of both of said coordinate systems as a stereo pair.

The principal axes of said left- and right-handed coordinate systems may be substantially parallel and spaced apart.

Any or all of the refractive elements may comprise a prism lens, which may be a right-angled triangular prism lens.

The or each optical element configured to propagate an optical beam incident thereon substantially straight through may comprise a cubic lens.

Another aspect of the invention extends to a method of capturing images of an area of interest using an image capture device having an input and an image sensor, comprising:
providing apparatus as described above at said input of said image capture device;
receiving parallel, spaced-apart optical beams at different respective areas of said image sensor to generate respective image data; and
processing said image data to generate respective orthogonal images of said area of interest.

Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of embodiments, even if the other features and embodiments make no mention of the particular feature. Thus, the invention extends to such specific combinations not already described.

Thus, embodiments of the present invention will now be described by way of examples only and with reference to the accompanying drawings, in which:

FIG. 1 is a schematic diagram illustrating some of the principal components of a digital SLR camera according to the prior art;

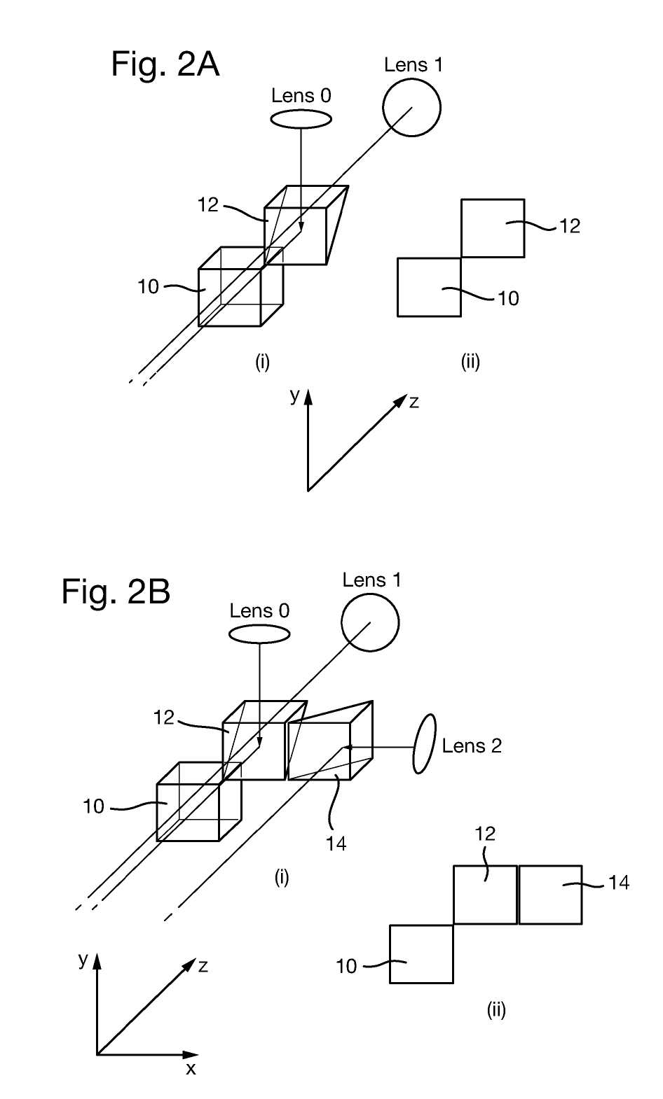

FIG. 2A is a schematic (i) perspective and (ii) rear view of apparatus according to a first exemplary embodiment of the present invention;

FIG. 2B is a schematic (i) perspective and (ii) rear view of apparatus according to a second exemplary embodiment of the present invention;

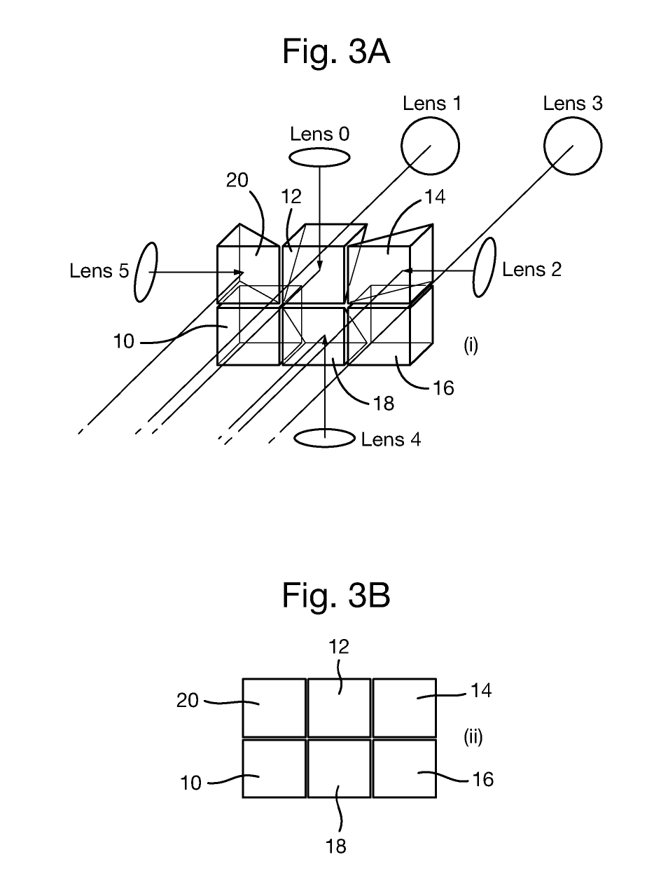

FIG. 3A is a schematic perspective view of apparatus according to a third exemplary embodiment of the present invention;

FIG. 3B is a schematic rear view of the apparatus of FIG. 3A;

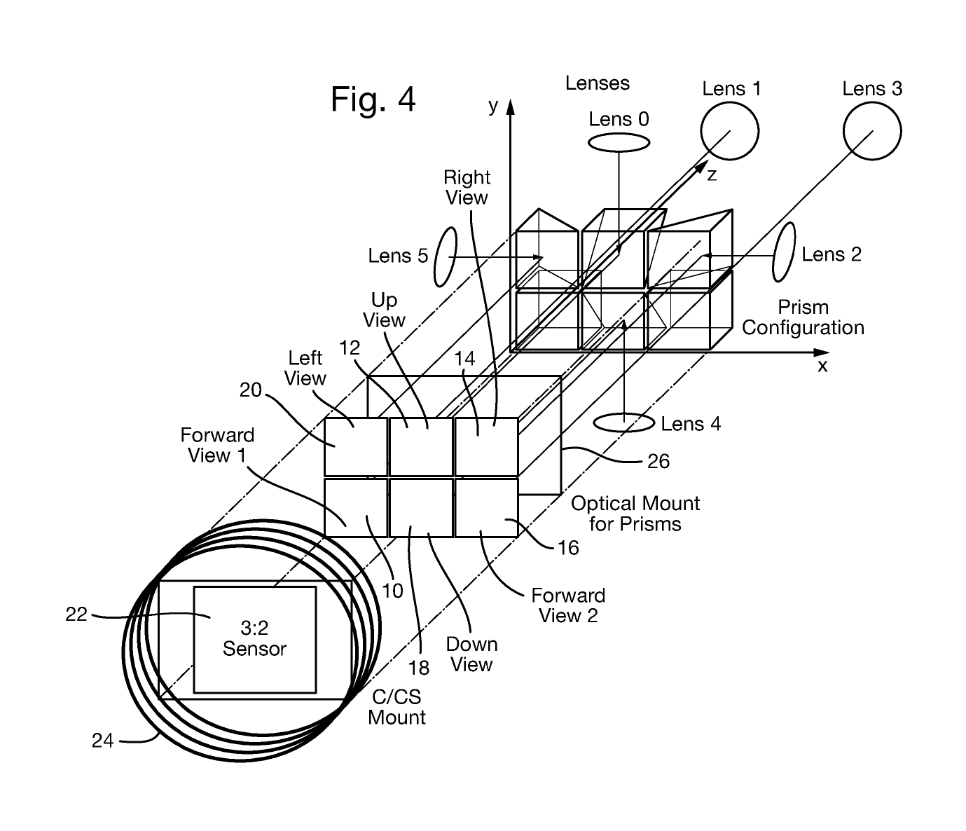

FIG. 4 is a schematic exploded view of apparatus according to a third exemplary embodiment of the present invention, when in use; and

FIG. 5 is a schematic diagram illustrating the concept of a stereo image pair comprised of monocular orthogonal images corresponding respectively to a right- and left-handed coordinate system.

Referring to FIG. 2A of the drawings, an optical imaging device according to a first exemplary embodiment of the present invention, comprises a lens unit comprising a cubic lens 10 and a right-angled triangular prism lens 12, mounted or otherwise configured relative to each other such that the planar surfaces of their rear faces are diagonally aligned, and the diagonal face of the prism lens 12 extends upwardly from the lower edge of its rear face. When mounted within an image capture device, a first imaging lens (lens0) is provided vertically above, and generally centrally, relative to the upper face of the prism lens 12, and a second imaging lens (lens1) is provided horizontally in line, spaced apart from, and generally centrally relative to the parallel front and rear faces of the cubic lens 10, described in relation to the specific orientation of the various elements as illustrated in the drawings.

In use, light is directed from the first imaging lens (lens0) through the top face of the prism lens 12, until it hits, and is refracted through 90° by, the diagonal face, in a rearward direction relative to the image capture device. Light is also directed from the second imaging lens (lens1) straight through the cubic lens 10 in a rear ward direction relative to the image capture device. Light from both imaging lenses (lens0, lens1) travels in the same direction, and in parallel, to different respective portions of a single image sensor (not shown), such that respective images corresponding to the fields of view of the first and second imaging lenses can be captured simultaneously and processed. It will be appreciated that an image processor will be provided for this purpose, which will include cubic and prism lens distortion compensation functionality, as required, but this will not be described in any further detail herein as it will be a familiar concept to a person skilled in the art.

In this way, two images of the same area of interest from two orthogonal aspects (corresponding in this case to the Z (principal) and Y axes) can be captured simultaneously using a single image sensor.

Referring now to FIG. 3B of the drawings, an imaging device according to a second exemplary embodiment of the present invention comprises a lens unit similar to that described in relation to FIG. 2A of the drawings, in that it comprises a cubic lens 10 and a right-angled triangular prism lens 12, configured relative to each other as previously described and illustrated. In this case, however, a second right-angled triangular prism lens 14 is mounted or otherwise provided immediately adjacent to the first prism lens 12, with the planar surfaces of their rear faces vertically and horizontally aligned. A third imaging lens (lens2) is provided in the image capture device, which is horizontally aligned, spaced apart from, and generally central relative to the side face of the second prism lens 14, and the diagonal face of the second prism lens 14 extends forward from the outer edge of the rear face to the outer edge of the side face thereof.

In use, as well as the light being directed from the first and second imaging lenses (lens0, lens1) to the image sensor, as before, light is directed from the third imaging lens (lens2), horizontally into the second prism lens 14, until it hits, and is refracted through 90° by, the diagonal face, thus again directed rearwardly relative to the device. In this way, three images of the same area of interest, from three orthogonal aspects (corresponding to the Z (principal), Y, and X axes of a left-handed coordinate system) can be captured simultaneously using a single image sensor.

Referring to FIGS. 3A, 3B and 4 of the drawings, an optical imaging device according to a third exemplary embodiment of the invention comprises a lens unit comprising the cubic lens 10 and the first and second prism lenses 12, 14 arranged and configured as described above in relation to FIG. 2B. The lens unit further comprises a second cubic lens 16 and third and fourth prism lenses 18, 20, the six lenses being configured in the form of a 6-face array 22 (from the perspective of the image sensor 24 at the rear of the image capture device), mounted in the optical path by means of, for example, a universal C/CS mount 26.

It can be seen from FIG. 3A of the drawings that the second cubic lens 16 is positioned in the bottom, right-hand corner of the array 22, the third right-angled triangular prism 18 is located in the bottom centre of the array 22, with its diagonal face extending downward from the upper edge of its rear face, and the fourth right-angled triangular prism 20 is located in the top left corner of the array 22, with its diagonal face extending forward from the right-hand rear edge thereof, in the specific orientation of elements illustrated. It will be appreciated that the lens unit of the present invention is not necessarily limited to the particular configuration described above, and may comprise any configuration of lenses that results in the desired functionality as described below.

Within the overall image capture device, three further imaging lenses (lens3, len4 and lens5) are provided: lens3 being located horizontally in line, spaced apart from, and generally centrally relative to the parallel rear and front faces of the second cubic lens 16; lens4 being located vertically below the lower face of the third prism lens 18; and lens5 being located horizontally in-line, spaced apart from, and generally centrally relative to the left face of the fourth prism lens 20.

Lenses 0, 1 and 2, the first cubic lens 10 and the first and second prism lenses 12, 14 operate in the same manner as before in order to generate three orthogonal views simultaneously, corresponding to the left-handed coordinate system. In addition, or alternatively, lenses 3, 4 and 5, the second cubic lens 16 and the third and fourth prism lenses 18, 20 can be used to generate three further orthogonal views simultaneously, this time corresponding to the right-handed coordinate system.

Thus, the lens unit described above according to the third exemplary embodiment of the invention comprises six lenses, integrated together, into a single camera attachment that allows two pairs of orthogonal views in respect of an area of interest to be generated, where each of the optical axes allow (selectively) for a left- or right-handed coordinate system, as required. In an alternative mode of operation, all six lenses can be used to generate a forward facing stereo pair (i.e. both left- and right-handed coordinate systems with the Z (principal) axes being closely spaced and parallel to each other) to be focused concurrently on a single camera sensor 22. A control function (not shown) may be provided to enable a user to select the desired mode of operation, if required.

Embodiments of the resultant lens unit can be designed to use a universal (e.g. C/CS) mount 24 so that it can be used with any known camera sensor technology. For example, it could be designed to be fitted to any commercially off-the-shelf digital SLR camera and, in the example illustrated in FIG. 4 of the drawings, the prism and cubic lenses, 10, 12, 14, 16, 18, 20 are housed on an optical mount 26 configured to be received within the C/CS mount 24 of a digital SLR camera. Alternative exemplary embodiments could be fixed to products having an integrated camera, without the need for a mount. For example, in one specific exemplary embodiment, the lens unit could be glued or otherwise fixed to the outside of a camera phone or a commercially off-the-shelf drone.

It will be appreciated from the foregoing description that modifications and variations can be made to the described embodiments, without departing from the scope of the invention as claimed.

1. An optical apparatus for use with an image capture device having an optical input and an image sensor defining a principal optical axis therebetween, the apparatus being configured to provide, via said input, a plurality of substantially parallel, spaced-apart optical beams to said image sensor, and comprising:
a first optical unit comprising a plurality of optical elements, at least a first one of said optical elements being a first refractive element for refracting an optical beam incident thereon through substantially 90°; and
a plurality of focusing lenses, each focusing lens being associated with a respective optical element and being configured to direct a respective incident optical beam thereon;
wherein the focusing lens associated with said refractive element is arranged and configured to direct an incident optical beam thereon at substantially 90° to said principal optical axis, and the refractive element is arranged and configured such that, in use, the resultant refracted optical beam is substantially parallel to said principal optical axis as it reaches said image sensor.

2. The apparatus according to claim 1, wherein said first optical unit comprises:
a first optical element comprising said refractive element; and
a second optical element configured to allow an optical beam incident thereon to propagate substantially straight through;
wherein the focusing lens associated with said first optical unit is arranged and configured to direct an incident optical beam thereon substantially parallel to said principal optical axis, said first and second optical elements being relatively positioned within said optical unit such that the respective optical beams output therefrom are spaced-apart and substantially parallel.

3. The apparatus according to claim 2, wherein the first optical unit comprises a third optical element being a second refractive element for refracting an optical beam incident thereon through substantially 90°, and wherein the focusing lens associated with said second refractive element is arranged and configured to direct an incident optical beam thereon at substantially 90° to said principal optical axis and substantially 90° to the incident optical beam directed onto said first refractive element, and the second refractive element is arranged and configured such that, in use, the resultant refracted optical beam is substantially parallel to said principal optical axis as it reaches said image sensor.

4. The apparatus according to claim 1, wherein the optical elements are housed in or on a single mount configured to be held within a lens mount of an image capture device.

5. The apparatus according to claim 3, wherein the incident optical beams directed to the three respective optical elements define three orthogonal axes of a left- or right-handed coordinate system.

6. The apparatus according to claim 3, comprising a second optical unit comprising three further optical elements: a fourth optical element for propagating an optical beam incident thereon substantially straight through, and two refractive elements, each for refracting an optical beam incident thereon through substantially 90°, and the apparatus comprises three further focusing lenses, each associated with a respective one of said three further optical elements, wherein a first of said focusing lenses is arranged and configured to direct an incident optical beam on said fourth optical element substantially parallel to said principal optical axis, and each of the other two of said focusing lenses are arranged and configured to direct an incident optical beam on a respective one of said refractive elements at substantially 90° to said principal optical axis and at substantially 90° to each other, such that the optical beams output from said second optical unit are spaced apart and substantially parallel to said principal optical axis and each other.

7. The apparatus according to claim 6, wherein said first optical unit comprises a first set of three optical elements for receiving incident optical beams in respect of three orthogonal axes of a left-handed coordinate system and outputting three parallel, spaced-apart optical beams representative thereof, and said second optical unit comprises a second set of three optical elements for receiving incident optical beams in respect of three orthogonal axes of a right-handed coordinate system and outputting three parallel, spaced-apart optical beams representative thereof.

8. The apparatus according to claim 7, wherein said first and second optical units are mounted or otherwise connected together to form an array of optical elements.

9. The apparatus according to claim 7, further comprising a control function for enabling a user to select, as an output from said optical unit, said optical beams representative of said left-handed coordinate system, said optical beams representative of said right-handed coordinate system, or the optical beams representative of both of said coordinate systems as a stereo pair.

10. The apparatus according to claim 7, wherein the principal axes of said left- and right-handed coordinate systems are substantially parallel and spaced apart.

11. The apparatus according to claim 1, wherein said refractive element is a prism lens.

12. The apparatus according to claim 11, wherein said refractive lens is a right-angled triangular prism lens.

13. The apparatus according to claim 1, wherein the or each optical element configured to propagate an optical beam incident thereon substantially straight through comprises a cubic lens.

14. A method of capturing images of an area of interest using the apparatus according to claim 1, comprising:
receiving parallel, spaced-apart optical beams at different respective areas of said image sensor to generate respective image data; and
processing said image data to generate respective orthogonal images of said area of interest.

15. The apparatus according to claim 2, wherein the optical elements are housed in or on a single mount configured to be held within a lens mount of an image capture device.

16. The apparatus according to claim 3, wherein the optical elements are housed in or on a single mount configured to be held within a lens mount of an image capture device.

17. The apparatus according to claim 8, further comprising a control function for enabling a user to select, as an output from said optical unit, said optical beams representative of said left-handed coordinate system, said optical beams representative of said right-handed coordinate system, or the optical beams representative of both of said coordinate systems as a stereo pair.

18. The apparatus according to claim 4, wherein said refractive element is a prism lens.

19. An optical tracking sensor for use in tracking motion, by visual odometry, of an object upon which the sensor is mounted, the sensor comprising:
a plurality of differently oriented prismatic optical elements;
a plurality of focusing lenses, each being associated with one of the plurality of prismatic optical elements to direct light from a respective field of view of an external scene into the associated prismatic optical element; and
an optical image sensor;
wherein each of the plurality of prismatic optical elements is arranged to direct light received by means of the associated focusing lens towards the optical image sensor such that light received over the field of view provided by each prismatic optical element is directed to a different portion of an image area of the optical image sensor.

20. The optical tracking sensor according to claim 19, wherein said optical tracking sensor is part of a closed-circuit television (CCTV) system.
